(19) United States
(12) Patent Application Publication
(10) Pub. No.: US 2006/0056511 A1
(43) Pub. Date: Mar. 16, 2006

(54) Flexible polygon motion estimating method and system

(75) Inventors: Mohamed M. Rehan, Vancouver (CA); Panajotis Agathoklis, Victoria (CA); Andreas Antoniou, Victoria (CA)

Correspondence Address: DARBY & DARBY P.C., P. O. BOX 5257, NEW YORK, NY, 10150-5257, US

(73) Assignee: University of Victoria Innovation and Development Corporation, Victoria (CA)

(21) Appl. No.: 11/212,486

(22) Filed: Aug. 26, 2005

Related U.S. Application Data
(60) Provisional application No. 60/604,884, filed on Aug. 27, 2004.

(51) Int. Cl. H04N 7/12; H04N 11/04; H04B 1/66; H04N 11/02

(52) U.S. Cl. 375/240.12; 375/240.24

(57) ABSTRACT

A method for block-based motion estimation, the flexible triangle search (FTS) algorithm is provided. The FTS is based on the simplex algorithm for optimization adapted to an integer grid. The proposed algorithm is highly flexible because of its ability to quickly change its search direction and to move toward the target of the search criterion. Motion estimation in a search window is in relation to a reference window. The motion estimation comprises searching. Searching is comprised of the steps of expanding, translating, contracting and reflecting. A system for block-based motion estimation is also provided.

### CROSS-REFERENCE TO RELATED APPLICATIONS

This application claims priority to U.S. provisional patent application Ser. No. 60/604,884, filed 27 Aug. 2004.

### FIELD OF THE INVENTION

The invention relates to a method for estimating motion to promote efficient video compression. More specifically, this invention is a method for estimating motion, using an integer grid and look up tables. A system for implementation of the method is also provided.

### BACKGROUND OF THE INVENTION

Video compression standards are used extensively in industrial applications such as video conferencing, video telephony, video surveillance, video streaming, video recording, video editing and digital camera/video capture (in the digital camera market). Motion estimation is one of the key components in several video compression algorithms and standards [1]-[7]. The main purpose of motion estimation is to reduce temporal redundancy between frames in a video sequence.

These functions are used as part of video compression standards such as, but not limited to, MPEG-1, MPEG-2, H.263, and H.264. Motion estimation functions find blocks that closely match between two different video frames. Once these matching blocks are found, only the differences between those blocks are coded. As a result, fewer bits are needed to store or encode the block information. The more efficient the motion search algorithm, the better the compression that can be achieved. In addition, the quality of the coded video can also be indirectly improved when motion estimation is used. This is because when fewer bits are needed to code a video frame, the remaining bits can be used to improve the coding quality. In other words, two applications with the same bandwidth requirements but different motion estimation algorithms can produce different coded quality. In a typical video compression standard application with a video encoder, motion estimation computations account for approximately 30-50% of required computations by the encoder.

The Video Compression Process

The process of encoding video frames is shown in FIG. 1. Video frames are divided into three main video types I, P, and B. I, P, and B are the frame types in video compression. I is Intra coded frame and does not require motion estimation. P is Predicted frame. The coding of this frame is done using motion estimation with respect to a previous I or P frame. B is Bidirectional predicted frame. B frames are coded using motion estimation with reference to the previous or next frame in time. While there are differences between encoding video frames, in general, each frame is divided into macroblocks. Discrete Cosine Transform “DCT” and Quantization is applied to each block. The resultant data are then coded using variable length coding.

DCT is applied to each block as given by the equation

$$F ( u , v ) = \frac{1}{4} C ( u ) C ( v ) {\sum }_{m = 0}^{7} {\sum }_{n = 0}^{7} f ( m , n ) cos ( \frac{π ( 2 m + 1 ) u}{16} ) cos ( \frac{π ( 2 n + 1 ) v}{16} )$$

where u, v, m. n=0, 1, . . . , 7, and

$$C ( ω ) \{ \begin{matrix}\frac{1}{\sqrt{2}} & ω = 0 \\ 1 & otherwise\end{matrix}$$

Then the DCT coefficients are uniformly quantized.

The coefficient F(0,0) is called the DC coefficient while all other coefficients are called AC coefficients. The DC coefficient F(0,0) is divided by 8, and the result is rounded to the nearest integer in [−256, 255], i.e.,
QF(0,0)=NINT[F(0,0)/8]
where NINT is the nearest integer value.

The AC coefficients, i.e. F(u,v), are first multiplied by 16, and the result is divided by a weight, Q(u,v), times the quantizer scale (MQUNAT)

$$QF [ u , v ] = \frac{16 F [ u , v ]}{qQ [ u , v ]}$$

where Q[u,v] is the quantization matrix and q is MQUNAT. The quantization matrix sets the relative quantization step for each coefficient in the block. MQUNAT is used as another factor to satisfy the required bit rate. MQUNAT together with the quantization matrix determine the actual quantization factor and actual coarseness of the block. The quantization matrix can be altered for each sequence in MPEG-1 as well as each picture in MPEG-2. On the other hand, MQUNAT can be changed for each macroblock.

In coding of I frames, the quantized coefficients are scanned in a zigzag pattern and ordered into symbols. Each symbol consists of a [run, level] pair. The level indicates the value of nonzero coefficient while run indicates the number of preceding zeros to that symbol. The symbols are then coded using a variable length coder.

P and B frames are inter-coded using ME/MC (Motion Compensation). In ME/MC[19], the frame which is being compressed is called the current frame. The nearest I or P frame is called the reference frame. ME algorithms work on macroblock level. Block matching algorithms BMAs [20-28] are used to find the macroblock in the reference frame that has minimum difference from the macroblock being coded in the current frame. The main idea of BMA is to reduce the amount of computations by either reducing the search area or the number of search steps [1]. After motion estimation, the displacement vector and the prediction difference error can be used to reconstruct the macroblock. The prediction error is DCT processed and quantized. The remaining step involves entropy coding is similar to that of I frames.

Motion estimation can be done with respect to a previous or next reference frame in the time domain. If the reference frame is before the current frame, this kind of ME is called forward ME. If the reference frame is after the current frame, it is called backward ME. Sometimes two reference frames can be used together and this is called bidirectional motion compensation. P frames are coded using the immediate previous I, or P frames (forward prediction). B-frames, on the other hand, are coded using forward prediction as in P frames, backward predication using a future reference frame, or bidirectionally coded using both future and past frames.

Macroblocks can have different types even within a single I, P, or B pictures. In I picture macroblocks can be coded with different effective quantization matrices and without ME. This type of macroblocks is referred to as intra-macroblock. In a P picture, a macroblock can be coded as intra-macorblock or inter-macroblock. Inter-macroblocks are coded using ME/MC. Sometimes after quantisization of a macroblock, all coefficients are zero, so there is no need to code that macroblock. This is called a skipped macroblock.

Sometimes it is more efficient not to perform ME/MC. In this case the motion vector is set to zero. This type of motion vector is called zero motion vector. In a B picture, macroblock types are similar to those in P pictures except there is an additional of forward and bidirectional coded macroblock. The choice of a macroblock type depends on the picture type and how much compression each macroblock type will provide.

At the decoder side, the operation is the reverse to that of the encoder side. Coefficients of each block are decoded, then inverse quantization as well as transformation decoding is applied to each the blocks of each macroblock. Motion compensation is then applied to macroblocks coded using motion estimation. Finally, frames are reordered back and the decoder output is according to their temporal reference.

Motion Estimation Algorithms:

Motion estimation (ME) algorithms can be classified as block-based, pixel-based, or region-based. Block-based algorithms are the most popular because of the simplicity in both software and hardware.

In block-based motion estimation, each frame is divided into a group of equally sized blocks called macroblocks and a single vector is used to represent motion for each macroblock. This motion vector is obtained by finding the best match between the block in the frame to be compressed, called the current frame, and the reference frame. The main parameters of the block-based motion estimation (ME) process are the search window size, the matching criterion, and the search algorithm. The search window is the area in the search frame in which the search for the best matching block is performed between the search window and the corresponding window in the reference frame (the reference window). The search window is defined by the location of its origin (its upper left corner) and its size. The matching criterion is the evaluation function that measures the degree of matching between two blocks. Different matching criteria are available such as, but not limited to, the sum of absolute difference (SAD), the cross correlation (CC) and the mean-square error (MSE). SAD is the most commonly used because of the simplicity and ease of its implementation. SAD is Determined as:

$$SAD ( {V}_{i} ) = {\sum }_{x = 0}^{M} {\sum }_{y = 0}^{N} \vert {S}_{l} ( x , y ) - {S}_{l - 1} ( x + dx , y + dy ) \vert$$

where M and N are the block width and height, respectively, Sl(x,y) is the pixel value of frame l at relative position x,y from the macroblock origin, and Vi=(dx,dy) is the displacement vector.

There is a wide range of block matching algorithms, (BMAs) presented in the literature [8-23]. A full or exhaustive search is the simplest one leading to the minimum SAD in the search window. It has, however, the drawback of high computational complexity. This makes full search (FS) not suitable for real time video compression applications. Other available block matching algorithms apply fast search techniques such as 2-D logarithmic search (2DS) [9], cross search (CS) [10], three-step search (TSS) [11], hierarchical BMA [12], hexagon search (HS) [13], diamond search (DS) [14-16], and the simplex search (SS) [19-23]. In these algorithms, only selected subsets of search positions are evaluated. This reduces the amount of computation, but can lead to motion vectors corresponding to local minima of the matching criterion. The group of BMAs presented in [19-23] is based on the simplex optimization algorithm and has been found to yield quite good results. The use of the well known simplex optimization algorithm to find the minimum of the SAD is motivated by the fact that the simplex technique has the capacity to quickly change search direction and perform a coarse or fine search as necessary [17-18].

Performance Measurements:

In order to compare between different search algorithms, evaluation criteria are used. The performance of any video encoder can be measured using one or more of these criteria such as the computational complexity of the video encoder, the quality of the produced bitstream, and the resultant compression ratio. The computational complexity of the encoding process is related mainly to motion estimation part of the algorithm. Some fast motion estimation algorithms can almost produce the same bitstream quality and compression ratio with less computation overhead as compared to the slower motion estimation algorithms. The quality of the produced bitstream can be measured by both quantitative and qualitative measures. An example of the measurement criteria is the average peak signal to noise ratio (PSNR). This is used to compare quality of the coded video frame. In addition, the visual quality of the reconstructed frames is used as a qualitative or subjective measurement of the encoder performance.

PSNR is calculated as

$$PSNR = 10 log \frac{{255}^{2}}{MSE} ,$$

where

$$MSE = \frac{1}{NM} {\sum }_{k = 1}^{N} {\sum }_{l = 1}^{M} {( {o}_{i , j} ( k , l ) - {r}_{i , j} ( k , l ) )}^{2}$$

Where o_{i,j} is the pixel value at location (i,j) in the original frame, r_{i,j} is the pixel value at location (i,j) in the reconstructed frame. N, M are number of frame pixels in both horizontal and vertical directions.

The compression ratio can be measured by means of estimation accuracy. Estimation accuracy is defined as the measure of the accuracy of matches located. Estimation accuracy can be evaluated by measuring the entropy of prediction errors generated after ME/MC. Lower entropy indicates higher compression. The first order entropy (H) is given by

$$H = - {\sum }_{i = 1}^{N} {p}_{i} [ {log}_{2} ( {p}_{i} ) ]$$

where N bounds all possible error values. The histogram of prediction errors can be used for estimation of pᵢ where pᵢ is the probability of a symbol with value equal to i.
Hexagon-Based and Diamond-Based Search Algorithms:

The basic search unit for hexagon-based searching is a hexagon, and similarly, the basic search unit in diamond-based searching is a diamond. (See WO0232145 for a description of hex-based searching). In both cases, the size is fixed during the search and is only contracted once the final iteration is complete. Movement during the iterations is towards the minimum and will continue until no further improvement is obtained. A number of positions are evaluated, and a decision as to the next move is made. The next move can be one of translation, or one level contraction. There is no expansion.

Simplex Search Algorithm:

The simplex algorithm is a technique used in optimization when the derivatives of the performance index are not available, or difficult to obtain [18]. In the two-dimensional simplex search, a search triangle is used to locate a minimum of the performance index or error function. The search domain is a continuous domain rather than an integer-based domain. The error function is evaluated at the triangle vertices, which represent possible minimum locations. The locations of the triangle vertices are modified in a manner that moves the triangle towards possible minimum locations by moving the triangle away from locations of high error function values. Only one point in the triangle is changed at any given time. During these movements, the search triangle can undergo the operations of reflection, expansion, and contraction. These operations are required to efficiently move the triangle towards the minimum location or resize the triangle. Consequently, the search can quickly change direction depending on the search results, or become more coarse or more fine as necessary. The algorithm's main operations can be briefly described as follows:

Reflection: In this operation the triangle is reflected away from the vertex with the maximum error value. The vertex with the maximum error value is identified and its new location is calculated by reflecting it with respect to the remaining two vertices. If the value of the error function at the vertex after reflection is less than the value of the error function at the location before reflection, then the reflection operation is considered to be successful and a new triangle with the new vertex instead of the maximum-error vertex is obtained. Thus, using reflection, the triangle is moved in the direction of the minimum error.

Expansion: After a successful reflection the possibility of finding a vertex with lower error function value can be further investigated by moving the reflection vertex further in the same direction. If the value of the error function at the vertex obtained after expansion is lower than the error function value at the vertex after reflection, the vertex obtained after expansion is used as the vertex of the search triangle. Thus expansion increases the size of the triangle allowing it to move faster towards the minimum using a coarser search.

Contraction: The contraction operation is the opposite of expansion. It is used when both reflection and expansion operations fail. In such a case, the search triangle is close to the minimum location and the size of the triangle is reduced to conduct a finer search and find the minimum location. If the algorithm has already reached the lowest triangle size and no more contraction can be achieved, then the algorithm stops.

The ability of the simplex algorithm to change the search direction and to switch between coarse and fine searches makes it a good candidate to be used for BMA [19-23]. However, the original simplex algorithm was intended for continuous variables while BMAs are required to use a discrete grid for the variables. The movement of the triangle is therefore not completely controllable. This sometimes results in the collapse of the triangle into one or two vertices. Further, the simplex search requires many floating-point calculations, which makes the search slower compared to other integer-based algorithms. It is an object of the invention to overcome the deficiencies in the prior art.

### SUMMARY OF THE INVENTION

The invention provides a new fast BMA developed by adapting the simplex algorithm to a discrete search grid. This algorithm begins with predefined sets of triangles. Through the use of the predefined sets of triangles the search operations can be carried out without floating point operations and without having to adapt the triangle obtained at each step of the algorithm to the discrete search grid. Once underway, the search is able to change the size of the triangles to allow for coarse and fine searches.

In one embodiment of the invention a method for estimating block motion in a search window for use in compression of two dimensional data, for example, video outputs is provided. The motion estimation in the search window is in relation to a reference window, and comprises searching, which in turn comprises initiating formation of a polygon, then expanding, translating, contracting and reflecting the polygon, such that in use, coding information is provided to improve the performance of compression.

In another aspect of the invention, the search window is in a current frame and the reference window is in a frame before or after the current frame.

In another aspect of the invention, the search window and the reference window are comprised of a plurality of points, a selected search point in the search window comprising a vertex of said polygon, the vertex corresponding with a reference point in the reference window.

In another aspect of the invention, the method is further defined as determining an error value between the vertex and the reference point.

In another aspect of the invention, searching moves away from vertices having maximum error values.

In another aspect of the invention, searching is integer-based.

In another aspect of the invention the method further comprises computing using look up tables.

In another aspect of the invention expanding is further defined as changing at least two vertices.

In another aspect of the invention, expanding is further defined as changing at least three vertices.

In another aspect of the invention, contracting is further defined as changing at least two vertices.

In another aspect of the invention, contracting is further defined as changing at least three vertices.

In another aspect of the invention, expanding and contracting occur repetitively, such that in operation, an area defined by the vertices increases and decreases successively.

In another aspect of the invention, determining an error value is further defined as determining a sum of absolute difference.

In another aspect of the invention, the polygon is a triangle.

In another aspect of the invention, the polygon is a parallelogram.

In another aspect of the invention, the polygon is a hexagon.

In another embodiment of the invention, a system for estimating block motion for coding and compressing two dimensional data, for example, video outputs is provided. The system comprises a search window, a reference window, and means for searching and comparing points between the reference window. The search window comprises selected search points and the reference window comprises reference points. The means for searching and comparing comprise means to initiate the search, means to expand the search, means to contract the search, means to reflect the search and means to translate the search, such that in use, coding information is provided to improve the performance of compressing two dimensional data.

In another aspect of the invention, the means for searching and comparing is integer-based.

In another aspect of the invention, the system further comprises look up tables.

In another aspect of the invention, the method further comprises coarse and fine searches.

In another aspect of the invention, the system is provided as computer hardware.

In another aspect of the invention, the system is provided as computer software

In another aspect of the invention, the software is provided as a CD ROM.

In another aspect of the invention, the software is provided on the world wide web.

### FIGURES

FIG. 1. Prior art showing the location of a motion estimator in coding and compressing data.

FIG. 2. Motion estimation in accordance with the method of the invention.

FIG. 3. Possible reflections for level 0 triangles in accordance with the method of the invention. The original triangle T00 is shown using a solid line and the resulting level 1 triangles are shown using dotted lines.

FIG. 4. Result of reflection followed by expansion of triangle T00 as outlined in Table 1, in accordance with the method of the invention.

FIG. 5. Relation between reflection, expansion, translation, contraction and triangle levels in accordance with the method of the invention.

FIG. 6. Flow chart of flexible polygon motion estimation in accordance with the method of the invention.

FIG. 7. Comparison between FS, FTS, MTSS and SS for PSNR vs frames.

FIG. 8. Comparison between FS, FTS, MTSS and SS for PSNR vs. Bit Rate for the Foreman QCIF.

### DETAILED DESCRIPTION OF THE INVENTION

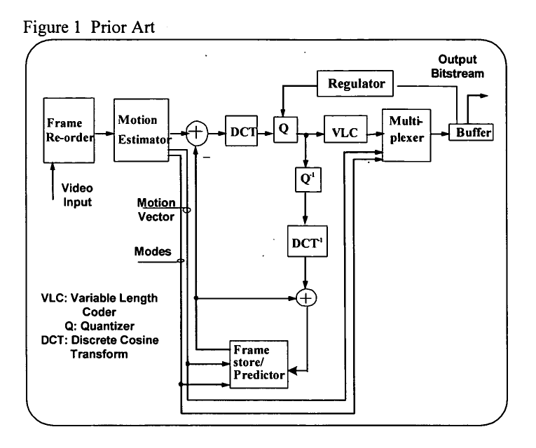

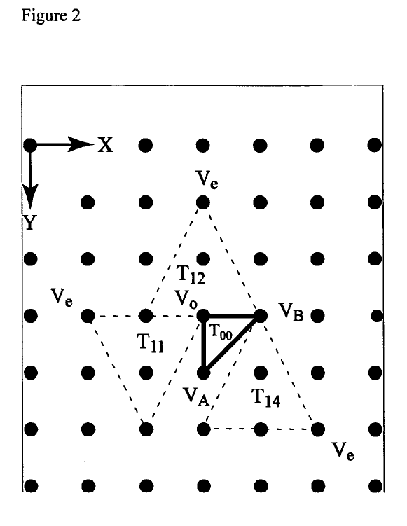

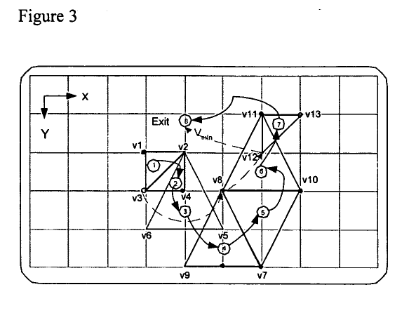

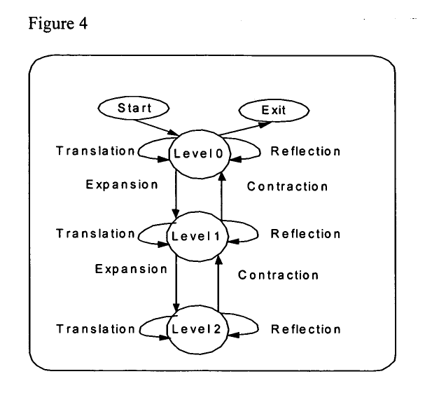

A system for estimating block motion for coding and compressing data, generally referred to as a motion estimator 10 is shown in the prior art of FIG. 1. The motion estimator 10 determines motion in a block 12 of a search window 14, with reference to a block 16 having the same location, but in a reference window 18, as shown in FIG. 2. The reference window 18 is in a reference frame 20 located either before or after the search window 14. The search window 14 is in the current frame 22. The search window 14 and the reference window 18 have a plurality of points 24 as shown in FIG. 3. Any given point 24 can be selected to form the vertex 26 of a polygon, which in the preferred embodiment is a triangle 28, but which can be a parallelogram or a hexagon, but is not limited to these shapes. The vertices 26, 30, 32 in the search window 14 correspond with reference points in the reference window 18. The search is based on using sets of triangles 34, 36, 38, for example, but not limited to three triangles of different sizes to perform the search, as shown in FIG. 4. The vertices 26, 30,32 of these triangles are always on an integer grid 40. The triangles 34, 36, 38 have different sizes to perform coarse or fine searches. A given triangle is defined by its identification id and its level, i.e., T21 stands for triangle T, id 2, and level 1. The ids for the three levels are:
Level 0={T00,T01,T02,T03}
Level 1={T10,T11,T12,T13,T14,T15}
Level 2={T20,T21,T22,T23,T24,T25}

The vertices 26, 30, 32 of the first triangle 34 are denoted as V0, VA, VB where V0 is the center point and VA, VB are the vertices 26, 30, 32 in counterclockwise rotation from V0. Thus, the coordinates of the three vertices 26, 30, 32 of the triangle 34 can be obtained from the triangle name and the coordinates of V0. More than three levels can be used, however, three levels are satisfactory for the commonly used window sizes.

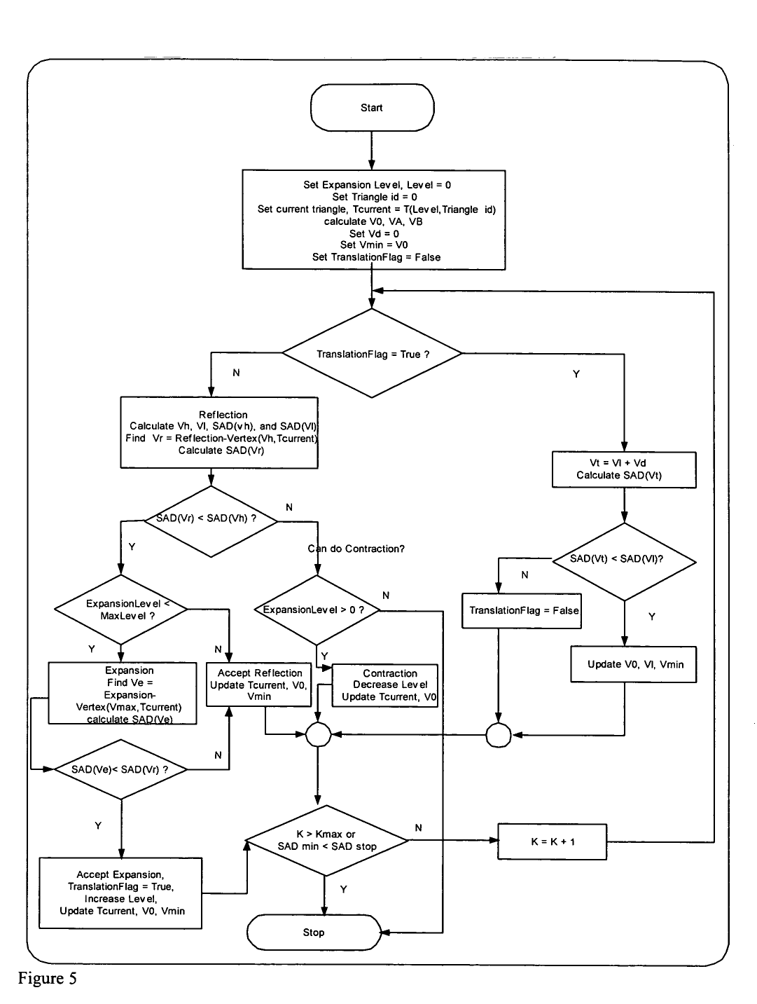

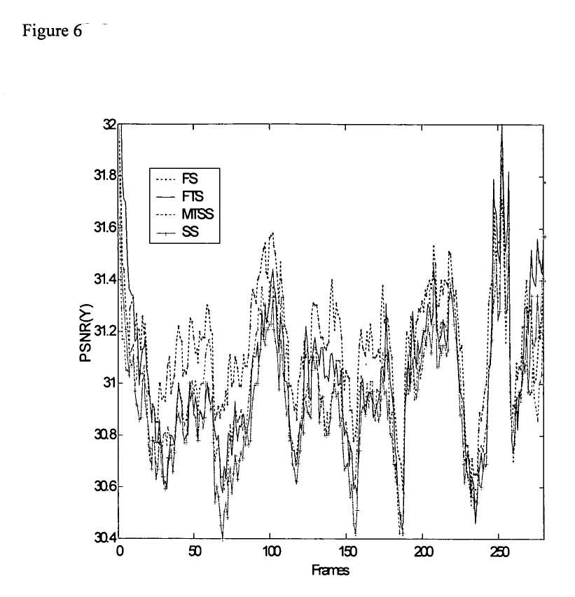

Based on the above definition of the triangles 34, 36, 38, the basic operations of the search (reflection, expansion, contraction, and translation) can be easily described using look-up tables, as shown in Table 1, and can be computed without floating point operations. The relationships between the various actions are shown in FIG. 5. Similar tables for reflection and expansion can be constructed for the other two levels. Contraction from level 2 to 1 is straightforward since the triangle orientation does not change. Table 2 presents contraction from level 1 to 0. The importance of these tables is that the search algorithm can be implemented using look-up tables and thus the computational efficiency can be greatly increased. A flow chart of a search is shown in FIG. 6.

The search algorithm can now be described as follows:
Given a reference frame Sl−1(x,y), an M×N macroblock in the current frame Sl(x,y), find the displacement vector Vmin so that SAD(Vmin) is minimized in the search window.

The details of the algorithm are as follows:
Prediction of the starting triangle
Prediction of starting triangle: Level 0 has 4 possible starting triangles T00, T01, T02, and T03. Select the triangle according to the following criterion
Calculate SAD values for 4 vertices surrounding the origin Vᵢ, i=1, 2, 3, 4
Calculate SAD for each quarter, Qᵢ as follows
   SAD(Qᵢ)=SAD(Vᵢ₊₁)+SAD(Vᵢ₊₂), i=0, 1, 2
   SAD(Q₃)=SAD(V₄)+SAD(V₁), i=3
Select Qₘᵢₙ=min(Qᵢ), i=0, 1, 2, 3
Select the triangle that lies in Qₘᵢₙ as FTS starting triangle
   SAD Buffer

FTS uses a SAD buffer to avoid repeated SAD computations. The SAD buffer is reset for each new Macroblock search before FTS starts. Then each newly computed SAD value is stored in the buffer. The stored value is indexed by x-y position. Then, for each additional SAD computation during FTS iterations, the SAD buffer is checked if it the required value has already been computed and stored. If the value is already stored, the stored value is used. Otherwise, the SAD value is computed and then stored in the buffer.

Step 1: Initialization

Initialize the current triangle level, current triangle within that set using steps above, and initial triangle vertices V0, VA, and VB in the search area. Choose V0 at the origin of the search window. Initialize the iteration counter K=0. Initialize translation vector Vd to 0 and displacement vector Vmin to V0. Reset or clear SAD buffer

Step 2

Determine the SAD for each new triangle vertex in the current triangle. Identify the vertex with the highest SAD value as Vh and the vertex with the lowest SAD value as Vl.

If the previous step was a successful expansion or translation operation, go to step 6, otherwise continue to step 3.

Step 3: Reflection

Get a new vertex Vr, by reflecting the Vh of the current triangle using the table corresponding to the current level and calculate SAD(Vr).

If SAD(Vr)<SAD(Vh), go to step 4, otherwise go to step 5.

Step 4: Expansion

Locate the expansion vertex Ve for the current triangle using the appropriate triangle level table.

If SAD(Ve)<SAD(Vr), then expansion was successful; increase the triangle level and update the current triangle. Calculate the translation vector between the reflection and expansion vertices, Vd using Vd=Ve−Vr.

If SAD(Ve)<SAD(Vmin), set Vmin=Ve. Go back to step 2 with K=K+1.

If SAD(Ve)>=SAD(Vr), then expansion was not successful. Update the current triangle by replacing Vh by Vr. If SAD(Vr)<SAD(Vmin) set Vmin=Vr. Go back to step 2 with K=K+1.

Step 5: Contraction

Contract the triangle by reducing the triangle level, update the current triangle and go to step 2 with K=K+1.

Step 6: Translation

Find a new vertex, Vt, by translating Vl using Vt=Vl+Vd and calculate SAD(Vt).

If SAD(Vt)<SAD(Vl), then translation was successful; replace Vl by Vt. If SAD(Vl)<SAD(Vmin), set Vmin=Vl. Go back to step 2 with K=K+1.

If SAD(Vt)>=SAD(Vl), then translation was not successful; set Vl as the origin of the next search triangle and continue from step 3 with K=K+1

Termination Conditions: The search is terminated if

No more successful reflections, expansions, or contractions operations are possible.

The number of search iterations reaches a pre-specified limit KMax.

The value of SAD becomes less than a pre-specified threshold ExitSAD.

### EXAMPLE 1

An example of the search pattern using the search of the present invention is shown in FIG. 4. The search starts at the center of the search window and concludes with finding Vmin the location with the minimum SAD.

1. Start:

The triangle search starts at level 0, current triangle T00 with initial vertices V1, V3, and V2. In this case SAD(V1) is the maximum and SAD(V3) is the minimum. Thus, V1 is set equal to Vh, V3 to Vl and Vmin to V3.

2. Reflection:

The triangle vertex V1 is reflected to V4. Since SAD(V4)<SAD(V1), reflection is successful and should be followed by expansion.

3. Expansion:

Test for expansion at V5 and since SAD(V5)<SAD(V4), expansion is successful. The current triangle is then expanded to T14 (based on Table 1) with vertices V2, V 5, and V 6. Vd is calculated from Vd=Ve−Vr=(1,1). Since in this case, SAD(V5)>SAD(Vmin), Vmin will not be updated.

4. Translation:

Since the last operation was a successful expansion, translation is attempted. Using the translation vector Vd=(1,1) from the expansion step, a translation of the current triangle is attempted to V7, V 8, and V 9. In this triangle, SAD(V9) is the maximum error, SAD(V 8) is the minimum error and this error is less then SAD(Vmin). As a result Vmin is updated to be equal to V8.

5. Reflection:

Since the last operation was a successful translation, more translation is attempted which does not lead to a vertex with a lower error than SAD(V8). Thus, a reflection is attempted by reflecting V9 to V10. Since SAD(V10)<SAD(V9), this is successful reflection. In the reflected triangle SAD(V7) is the maximum error. Further, SAD(V10)>SAD(V8) and Vmin is not updated.

6. Reflection:

Expansion is not successful, so reflection is attempted by reflecting V7 to V11. Since SAD(V11)<SAD(V8)<SAD(V7), the reflection was successful and also Vmin is updated to V11.

7. Contraction:

Expansion and reflection are not successful and thus contraction is attempted. Based on Table 2, T12 is contacted to T00. In the new triangle SAD(V12) is the lowest and is also lower than SAD(Vmin). Thus Vmin is updated to V12.

8. Exit:

Additional reflection does not lead to lower values for SAD. In addition, it is not possible to contract to a lower level. The algorithm will exit with the location of the minimum SAD value in Vmin.

V. Simulation Results

The search (referred to as FTS) was implemented as part of an H.263 encoder. The technique was compared with the modified-three-step search (MTSS) [11], the full search (FS), and the SS [19] algorithms. MTSS is well known for its low computation requirements while FS leads to the minimum SAD in the search range.

For purposes of comparison, scenes with different kinds of movement were used. QCIF sequences with 176×144 pixels (99 macroblocks) were used. Except for the search algorithm, all other encoding parameters were kept fixed. These parameters include:
Macroblock size (16×16)
Same search area size (32×32)
Same Rate control and quantization parameter selection
Motion vector prediction is included
Early exit condition when SAD value become less than a specified value (ExitSAD).
Same number of I and P frames

The comparison criteria were chosen to be the average number of block matching evaluations to evaluate computational complexity, the compression ratio to evaluate efficiency, and the peak signal to noise ratio (PSNR) between the original frames and the reconstructed frames to evaluate quality.

Table 3 lists the average number of block matching comparisons per frame obtained. As it can be seen, the average number of block matching comparisons required by the FTS is less than that of the MTSS, the FS, or the SS. As the average number of block matching comparisons is an indication of the computation complexity, and thus the speed of the algorithm, the results obtained confirmed that the FTS is faster than any of the other three techniques.

The compression ratio comparison results and average number of bits used for coding motion vectors are listed in Table 4 and Table 5 respectively.

Compression ratio results indicate that FTS is capable of producing almost the same compression as FS and slightly better compression than MTSS.

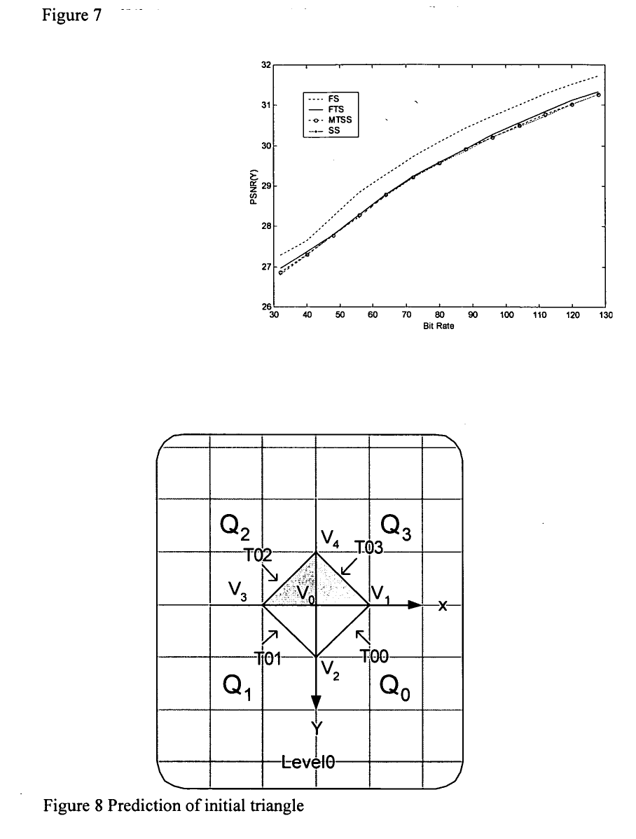

The average PSNR is shown in Table 6. In addition, FIG. 7 displays the PSNR values for each frame of the ‘foreman’ sequence for the four algorithms.

It can be inferred from FIG. 7 that the PSNR values produced by the FTS are comparable to those of MTSS and very close to those of FS. However, the SS has a lower PSNR value. FIG. 8 shown the change of PSNR at different bit rates. Except for FS, FTS is comparable to the other algorithms.

From the above comparison, it is clear that the compression ratios, as well as the average PSNR and visual quality of the reconstructed frames using FTS, MTSS and FS, are not significantly different. This indicates that the significant reduction of the computational complexity obtained using the FTS was not at the expense of deterioration in visual quality or compression efficiency.

Half-Pixel FTS

The FTS was also implemented at half-pixel accuracy. In the general case, the FTS is used at full-pixel accuracy to get a full-pixel motion vector. Then a separate or independent algorithm is used to determine the half-pixel accuracy. Results indicate the number of block matching required by full-pixel and half-pixel were almost the same even so full-pixel is more complicated. These results are attributed to the efficiency of FTS at full-pixel level. As a result, an extended version of FTS was used where FTS perform the search directly at half-pixel accuracy. In this case, an interpolated search area is used instead of the default search area. The use of this extension to FTS eliminates the need for using a half-pixel stage after the full-pixel stage.

The foregoing is a description of the preferred embodiment of the invention. As would be known to one skilled in the art, variations that do not alter the scope of the invention are contemplated. For example, while a method is described, the described invention also contemplates hardware, such as a chip, or software to provide the method. The software may be available to individual users, for example on a CD ROM, or may be accessed over the web.

TABLE 1

| | | Results of | | | | Results of | | Expansion | | Results of | | Expansion | |
|---|---|---|---|---|---|---|---|---|---|---|---|---|---|
| | | reflection of | | Expansion of | | reflection of | | of V_{A} | | reflection of | | of V_{B} | |
| | | V₀ around | | V₀ reflection- | | V_{A} around | | reflection- | | V_{B} around | | reflection- | |
| | | V_{A}, V_{B} | | vertex | | V₀, V_{B} | | vertex | | V₀, V_{A} | | vertex | |
| Current | | New | Origin | Test | New | New | Origin | Test | New | New | Origin | Test | New |
| Triangle, | | Triangle, | Shift | Point | Triangle, | Triangle, | Shift | Point | Triangle, | Triangle, | Shift | Point | Triangle, |
| Level 0 | | Level 0 | V₀ | Ve | Level 1 | Level 0 | V₀ | Ve | Level 1 | Level 0 | V₀ | Ve | Level 1 |
| T00 | 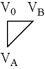 | T02 | (1,1) | (2,2) | T14 | T03 | (0,0) | (0,−2) | T12 | T01 | (0,0) | (−2,0) | T11 |
| T01 | 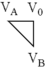 | T03 | (−1,1) | (−2,2) | T10 | T00 | (0,0) | (2,0) | T13 | T02 | (0,0) | (0,−2) | T12 |
| T02 | 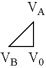 | T00 | (−1,−1) | (−2,−2) | T11 | T01 | (0,0) | (0,2) | T15 | T03 | (0,0) | (2,0) | T14 |
| T03 | 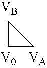 | T01 | (1,−1) | (2,−2) | T13 | T02 | (0,0) | (−2,0) | T10 | T00 | (0,0) | (0,2) | T15 |

TABLE 2

| Level 1 | |
|---|---|
| Original | Level 0 |
| Triangle | New Triangle |
| T10 | T03 |
| T11 | T00 |
| T12 | T00 |
| T13 | T01 |
| T14 | T02 |
| T15 | T02 |

TABLE 3

| Sequence | FS | MTSS | SS | FTS |
|---|---|---|---|---|
| Akyio | 780.63 | 21.49 | 14.43 | 6.21 |
| News | 774.77 | 21.48 | 14.41 | 6.62 |
| Miss | 765.35 | 21.50 | 16.80 | 10.45 |
| America | | | | |
| Foreman | 710.94 | 21.81 | 15.39 | 8.49 |
| Coastguard | 719.88 | 21.60 | 14.96 | 7.32 |
| Carphone | 745.28 | 21.46 | 15.87 | 8.32 |
| Silent | 760.62 | 21.46 | 14.68 | 7.29 |

TABLE 4

| Sequence | FS | MTSS | SS | FTS |
|---|---|---|---|---|
| Akyio | 217 | 212 | 214 | 216 |
| News | 96 | 92 | 94 | 95 |
| Miss | 247 | 223 | 237 | 229 |
| America | | | | |
| Foreman | 66 | 52 | 50 | 49 |
| Coastguard | 42 | 38 | 32 | 34 |
| Carphone | 93 | 87 | 86 | 84 |
| Silent | 109 | 107 | 102 | 103 |

TABLE 5

| Sequence | FS | MTSS | SS | FTS |
|---|---|---|---|---|
| Akyio | 78 | 80 | 75 | 76 |
| News | 165 | 171 | 144 | 145 |
| Miss | 222 | 235 | 205 | 206 |
| America | | | | |
| Foreman | 773 | 850 | 485 | 465 |
| Coastguard | 601 | 616 | 474 | 474 |
| Carphone | 474 | 466 | 374 | 373 |
| Silent | 279 | 251 | 210 | 217 |

TABLE 6

| Sequence | FS | MTSS | SS | FTS |
|---|---|---|---|---|
| Akyio | 33.83 | 33.83 | 33.80 | 33.80 |
| News | 31.89 | 31.92 | 31.90 | 31.85 |
| Miss | 36.36 | 36.19 | 36.28 | 36.38 |
| America | | | | |
| Foreman | 31.07 | 30.76 | 30.86 | 31.07 |
| Coastguard | 29.69 | 29.63 | 29.56 | 29.62 |
| Carphone | 32.40 | 32.27 | 32.32 | 32.38 |
| Silent | 31.87 | 31.91 | 31.97 | 31.97 |

### REFERENCES

[1] ISO/IEC 11172, “Coding of Moving Pictures and Associated Audio for Digital Storage Media at up to about 1.5 Mbits/s,” International Organization for Standardization, 1992.

[2] ISO/IEC CD 13818, “Generic Coding of Moving Pictures and Associated Audio,” International Organization for Standardization, 1994.

[3] D. Le Gall, “MPEG: a video compression standard for multimedia Applications,” Communications of the ACM, vol. 34, no. 4, pp. 47-63, April 1991.

[4] D. Le Gall, “The MPEG video compression algorithm,” Signal Processing: Image Communication, vol. ˜4, pp. 129-140, 1992.

[5] G. Morrison, “Video coding standards for multimedia: JPEG, H.261, MPEG”, IEE Colloquium on Technology Support of Multimedia, Digest no. 088, pp. 2.1-2.4, April 1992.

[6] V. Bhaskaran and K. Konstantinides, Image and Video Compression Standards Algorithms and Architectures, Kluwer Academic Publishers, Boston, September 1995.

[7] P. Kuhn, Algorithms, Complexity Analysis and VLSI Architectures for MPEG-4 Motion Estimation, Kluwer Academic Publishers, Boston, 1999.

[8] H. Musmann, P. Pirsch, and H. Grallert, “Advances in picture coding,” Proc. IEEE, vol. 73, no. 4, pp. 523-548, April 1985.

[9] J. Jain and A. Jain, “Displacement measurement and its application in interframe image coding,” IEEE Trans. Commun., vol. 29, no. 12, pp. 1799-1806, 1981.

[10] M. Ghanbari, “The cross-search algorithm for motion estimation,” IEEE Trans. Commun., vol. 38, no. 7, pp. 950-953, July 1990.

[11] T. Koga, “Motion compensated interframe coding for video conferencing,” Proc. National Telecommunications Conference, New Orleans, Nov. 29-Dec. 3, G5.3.1-G5.3.5, 1981.

[12] B. Paul and E. Viscito, “Hierarchical motion estimation with 2-scale tilings,” In Proc. of IEEE International Conference on Image Processing, pp. 260-264, 1994.

[13] C. Zhu, X. Lin, and L.-P. Chau, “Hexagon-based search pattern for fast block motion estimation,” IEEE Transactions on Circuits and Systems for Video Technology, vol. 12, no. 5, pp. 349-355, 2002

[14] C.-H. Cheung and L.-M. Po, “A novel cross-diamond search algorithm for fast block motion estimation,” IEEE Transactions on Circuits and Systems for Video Technology, vol. 12, no. 12, pp. 1168-1177, 2002

[15] S. Zhu and K.-k. Ma, “A new diamond search algorithm for fast block-matching motion estimation,” IEEE Transactions Image Processing, vol. 9, pp. 287-290, 2000.

[16] J. Y. Tham, S. Ranganath, M. Ranganath, and A. A. Kassim, “A novel unrestricted center-biased diamond search algorithm for block motion estimation,” IEEE Transactions on Circuits and Systems for Video Technology, vol. 8, pp. 369-377, 1998

[17] D. Himmelblau, Applied Nonlinear Programming, McGraw-Hill Inc., New York, 1972.

[18] B. Bunday, Basic Optimization Methods, Edward Arnold Publishers, 1984.

[19] M. Rehan, A. Antoniou, and P. Agathoklis, “A new fast block matching algorithm using the simplex technique,” Proc. of the IEEE Symposium on Advances in Digital Filtering and Signal Processing, 1998, pp. 30-33.

[20] M. E. Al-Mualla, C. N. Canagarajah, and D. R. Bull, “A simplex minimization for single and multiple-reference motion estimation,” IEEE Transactions on Circuits and Systems for Video Technology, vol. 11, no. 12, pp. 1209-1220, 2001.

[21] M. E. Al-Mualla, C. N. Canagarajah, and D. R. Bull, “Simplex minimisation for multiple-reference motion estimation”, Circuits and Systems, 2000. Proceedings. ISCAS 2000 Geneva. The 2000 IEEE International Symposium on, vol 4, 28-31, pp 733-736 vol. 4, 2000.

[22] M. E. Al-Mualla, C. N. Canagarajah, and D. R. Bull, “Simplex minimisation for fast long-term memory motion estimation”, Electronics Letters, vol: 37, issue: 5, pp 290-292, 2001

[23] M. E. Al-Mualla, C. N. Canagarajah, and D. R. Bull, “Simplex minimisation for fast block matching motion estimation”, Electronics Letters, vol: 34, issue: 4, pp 351-352, 1998

[24] M. Rehan, P. Agathoklis, and A. Antoniou, “Flexible triangle search algorithm for block-based motion estimation” Proc. of the IEEE PACRIM Conf. on Communications, Computers and Signal Processing, Victoria, BC, August 2003, pp. 233-236.

1. A method for estimating block motion in a search window for use in compression of two dimensional data, for example, video outputs, wherein said estimating block motion in said search window is in relation to a reference window, and said motion estimation comprises searching, said searching comprising initiating formation of a polygon, then expanding, translating, contracting and reflecting said polygon, such that in use, coding information is provided to improve the performance of compression.

2. The method of claim 1 wherein said search window is in a current frame and said reference window is in a frame before or after said current frame.

3. The method of claim 2 wherein said search window and said reference window are comprised of a plurality of points, a selected search point in said search window comprising a vertex of said polygon, said vertex corresponding with a reference point in said reference window.

4. The method of claim 3, further defined as determining an error value between said vertex and said reference point.

5. The method of claim 4 wherein said searching moves away from vertices having maximum error values.

6. The method of claim 5 wherein said searching is integer-based.

7. The method of claim 6 further comprising computing using look up tables.

8. The method of claim 7 wherein expanding is further defined as changing at least two vertices.

9. The method of claim 8 wherein expanding is further defined as changing at least three vertices.

10. The method of claim 9 wherein contracting is further defined as changing at least two vertices.

11. The method of claim 10 wherein contracting is further defined as changing at least three vertices.

12. The method of claim 11 wherein expanding and contracting occur repetitively, such that in operation, an area defined by said vertices increases and decreases successively.

13. The method of claim 12 wherein determining an error value is further defined as determining a sum of absolute difference.

14. The method of claim 13 wherein said polygon is a triangle.

15. The method of claim 13 wherein said polygon is a parallelogram.

16. The method of claim 13 wherein said polygon is a hexagon.

17. A system for estimating block motion for coding and compressing two dimensional data, for example, video outputs, said system comprising:
a search window, said search window comprising selected search points;
a reference window, said reference window comprising reference points; and
means for searching and comparing points between said reference window, said means comprising:
means to initiate said search:
means to expand said search;
means to contract said search;
means to reflect said search; and
means to translate said search,
such that in use, coding information is provided to improve the performance of compressing two dimensional data.

18. The system of claim 17 wherein said means for searching and comparing is integer-based.

19. The system of claim 18, further comprising look up tables.

20. The system of claim 19, wherein said system is provided as computer hardware.

21. The system of claim 19, wherein said system is provided as computer software.

22. The system of claim 21 wherein said software is provided as a CD ROM.

23. The system of claim 21 wherein said software is provided on the world wide web.

24. The method of claim 13, further comprising coarse and fine searches.
